(19) United States
(12) Patent Application Publication
(10) Pub. No.: US 2025/0344626 A1
(43) Pub. Date: Nov. 13, 2025

(54) Pulled Implement Tracking via Tractor and Implement Shared Data

(71) Applicant: Ag Leader Technology, Inc., Ames, IA (US)

(72) Inventors: Trent Anagnostopoulos, Ankeny, IA (US); Josue Calderon, Apex, NC (US); David Wilson, Prairie City, IA (US)

(73) Assignee: Ag Leader Technology, Inc., Ames, IA (US)

(21) Appl. No.: 19/205,840

(22) Filed: May 12, 2025

Related U.S. Application Data
(60) Provisional application No. 63/646,224, filed on May 13, 2024.

(51) Int. Cl. A01B 79/00; A01B 69/00

(52) U.S. Cl. CPC A01B 79/005; A01B 69/003

(57) ABSTRACT

A method for tracking a position of an agricultural implement pulled by a vehicle includes receiving by a processing device position data of the vehicle from a global navigation satellite system (GNSS) receiver mounted on the vehicle, receiving by the processing device inertial measurement data from an inertial measurement unit mounted on the agricultural implement, projecting by the processing device the position data of the vehicle to a connection point between the vehicle and the agricultural implement based on predefined measurements between a known position on the vehicle and the connection point, determining by the processing device an initial heading of the agricultural implement based on a predetermined initialization procedure, and calculating by the processing device a position and orientation of the agricultural implement by computationally combining the projected position data at the connection point and the inertial measurement data from the inertial measurement unit.

### PRIORITY STATEMENT

This application claims priority to U.S. Provisional patent application No. 63/646,224, filed May 13, 2024, hereby incorporated by reference in their entireties.

### FIELD OF THE INVENTION

The present disclosure relates to a method for calculating a highly accurate position estimate of a pulled implement. More particularly, but not exclusively, the present disclosure relates to Pulled Implement Tracking via Tractor and Implement Shared Data.

### BACKGROUND

Many agricultural tasks require or are improved by accurately estimating the operating implement's position. An accurate estimate of a pulled implement's position allows for correct mapping of the agricultural operation, controlling to a desired implement location, and path planning.

Estimating that position becomes difficult when the implement does not remain fixed with respect to the vehicle. Pulled implements rotate about some connection point and therefore the implement's heading can deviate from the pulling vehicle's heading. The deviating is caused by differences in turning radius, falling down side slopes, muddy or rough terrain, and various other causes.

One previous solution is to place a GNSS system on the pulled implement. This provides a globally referable position for where the implement has or is operating. The GNSS solution requires little processing to output on the data needed for uses such passive implement steering, active implement steering, mapping or data for follow on operations. However, the position estimate is only as good as the signal provided by the GNSS system. High accuracy GNSS, such as RTK, is very expensive. Further, the GNSS system must be mounted with clear view of the sky. Finding a location flat and high enough can be difficult. Some implements have large containers for product and require the GNSS to be installed on top. As the GNSS is mounted higher, tilt and roll of the implement induce error in estimation of the location of the operation. To regain high accuracy, the GPS position must be roll and pitch corrected requiring another sensor and further cost.

Another solution calculates only the angle between the vehicle and the implement by placing an angular sensor on the connecting point between the two. This solution presumes that the pulling vehicle's position is known and the implement's position can be calculated by offsetting the vehicle position along the angle between the vehicle and the implement. Designing the required angular sensor is difficult. The variations in vehicles, implements and attachment points are so wide it requires too many specific sensor designs resulting in this solution not being in wide use throughout the agricultural industry.

Therefore, what is needed is providing accurate and cost-effective tracking solution for pulled agricultural implements.

### SUMMARY

Therefore, it is a primary object, feature, or advantage of the present disclosure to improve over the state of the art.

It is another object, feature, or advantage of the present disclosure to improve over the state of the art by providing a more accurate and cost-effective solution for tracking pulled agricultural implements without requiring expensive high-precision GNSS systems mounted directly on the implement.

It is a further object, feature, or advantage of the present disclosure to require only an inertial measurement system be installed on the implement, thereby leveraging the existing GNSS system typically installed on the towing vehicle. This approach significantly reduces hardware costs while maintaining high-precision positioning capability.

Another object, feature, or advantage is to provide a computationally efficient method for generating a highly accurate, roll-corrected implement position with stable heading estimation using sensor data integration techniques that compensate for implement movement independent of the towing vehicle.

Yet another object, feature, or advantage is to ensure reliable system initialization by verifying proper implement alignment behind the vehicle prior to beginning positional calculations, thereby increasing accuracy from the outset of operation.

A further object, feature, or advantage is to enable flexible installation of the inertial measurement unit in any orientation and at any position on the implement, with calibration procedures that accommodate various implement designs and configurations.

An additional object, feature, or advantage is to permit tracking of multiple application points on the implement simultaneously, enabling precise mapping of agricultural operations at the individual row, nozzle, or tool level.

Still another object, feature, or advantage is to enable both passive implement steering (by adjusting the vehicle's position) and active implement steering (by directly actuating implement steering mechanisms) based on the calculated position and orientation.

Yet another object, feature, or advantage is to facilitate precise path planning for subsequent field operations by generating high-accuracy position data during current operations, thereby enabling advanced agricultural practices such as strip till farming.

A further object, feature, or advantage is to provide a system that operates effectively in challenging field conditions including side slopes, rough terrain, or muddy conditions where implement heading commonly deviates from vehicle heading.

An additional object, feature, or advantage is to eliminate the need for specialized angular sensors at the connection point between the vehicle and implement, thereby reducing the complexity of installation and maintenance while accommodating a wider variety of vehicle-implement combinations.

One or more of these and/or other objects, features, or advantages of the present disclosure will become apparent from the specification and claims that follow. No single embodiment need provide each and every object, feature, or advantage. Different embodiments may have different objects, features, or advantages. Therefore, the present disclosure is not to be limited to or by any objects, features, or advantages stated herein.

According to one aspect, a method for tracking a position of an agricultural implement pulled by a vehicle includes receiving by a processing device position data of the vehicle from a global navigation satellite system (GNSS) receiver mounted on the vehicle, receiving by the processing device inertial measurement data from an inertial measurement unit mounted on the agricultural implement, projecting by the processing device the position data of the vehicle to a connection point between the vehicle and the agricultural implement based on predefined measurements between a known position on the vehicle and the connection point, determining by the processing device an initial heading of the agricultural implement based on a predetermined initialization procedure, and calculating by the processing device a position and orientation of the agricultural implement by computationally combining the projected position data at the connection point and the inertial measurement data from the inertial measurement unit.

The method may further include calculating the position and orientation of the agricultural implement using an extended Kalman filter that processes the projected position data as a position input at the connection point of the agricultural implement. The method may further include projecting the position data of the vehicle to the connection point by generating a vector that shifts the known position on the vehicle to the connection point, rotating the vector based on roll, pitch, and heading of the vehicle, and adding the rotated vector to the position data of the vehicle. The method may further include performing the predetermined initialization procedure by at least one of driving the vehicle in a substantially straight line for a predetermined distance, driving the vehicle in a predefined pattern including at least one of a circle, figure eight, or series of turns, or maintaining the vehicle in a stationary position while performing a series of implement movements. The method may further include when the predetermined initialization procedure includes driving the vehicle in a substantially straight line, verifying that the vehicle is traveling in the substantially straight line by calculating a curvature of the vehicle's path and comparing the calculated curvature to a threshold value, and initializing the agricultural implement to have the same heading as the vehicle after confirming the vehicle has traveled the predetermined distance in the substantially straight line.

The method may further include calibrating an orientation of the inertial measurement unit relative to the agricultural implement prior to calculating the position and orientation of the agricultural implement, wherein the inertial measurement unit is installed in any orientation and at any position on the agricultural implement. The method may further include calibrating the orientation of the inertial measurement unit by at least one of measuring a gravity vector in at least two opposing directions to determine roll and pitch orientation, performing a series of implement movements at varying speeds to determine orientation based on detected acceleration patterns, or aligning the implement with the vehicle in a known orientation and recording relative orientation offsets.

The method may further include calculating positions of multiple application points on the agricultural implement based on the calculated position and orientation of the agricultural implement, wherein the multiple application points are fixed relative to the connection point. The method may further include having the multiple application points include at least one of planter rows, sprayer nozzles, tillage shanks, rollers, or disks. The method may further include generating a map of field operations based on the calculated position and orientation of the agricultural implement, the map including precise locations of agricultural operations performed by the agricultural implement. The method may further include controlling a position of the agricultural implement using the calculated position and orientation to maintain the agricultural implement on a predetermined path. The method may further include controlling the position of the agricultural implement by at least one of passive implement steering by adjusting the vehicle's position to indirectly position the agricultural implement, or active implement steering by actuating a steering mechanism directly on the agricultural implement. The method may further include generating a path plan for a subsequent field operation based on the calculated position and orientation of the agricultural implement during a current field operation. The method may further include performing strip till farming by tracking positions of fertilizer application tools during a fertilizing operation, storing location data of fertilized furrows created by the fertilizer application tools, and guiding a planter during a subsequent planting operation based on the stored location data to align planter rows with the fertilized furrows.

According to another aspect, a system for tracking a position of an agricultural implement pulled by a vehicle includes a global navigation satellite system (GNSS) receiver mounted on the vehicle for providing position data of the vehicle, an inertial measurement unit mounted on the agricultural implement for providing inertial measurement data, and a processing device communicatively coupled to the GNSS receiver and the inertial measurement unit. The processing device is configured to project the position data of the vehicle to a connection point between the vehicle and the agricultural implement based on predefined measurements between a known position on the vehicle and the connection point, determine an initial heading of the agricultural implement based on a predetermined initialization procedure, and calculate a position and orientation of the agricultural implement by computationally combining the projected position data at the connection point and the inertial measurement data from the inertial measurement unit.

The system may further include the processing device being configured to calculate the position and orientation of the agricultural implement using an extended Kalman filter that processes the projected position data as a position input at the connection point of the agricultural implement. The system may further include the processing device being configured to calculate positions of multiple application points on the agricultural implement based on the calculated position and orientation of the agricultural implement, and generate a map of field operations including precise locations of agricultural operations performed at the multiple application points. The system may further include the processing device being configured to control a position of the agricultural implement using the calculated position and orientation to maintain the agricultural implement on a predetermined path, and generate a path plan for a subsequent field operation based on the calculated position and orientation of the agricultural implement during a current field operation. The system may further include the inertial measurement unit being installed in any orientation and at any position on the agricultural implement, and wherein an orientation of the inertial measurement unit relative to the agricultural implement is determined through calibration prior to calculating the position and orientation of the agricultural implement.

According to yet another aspect, a non-transitory computer-readable medium storing instructions that, when executed by a processor, cause the processor to perform operations includes receiving position data of a vehicle from a global navigation satellite system (GNSS) receiver mounted on the vehicle, receiving inertial measurement data from an inertial measurement unit mounted on an agricultural implement pulled by the vehicle, projecting the position data of the vehicle to a connection point between the vehicle and the agricultural implement based on predefined measurements between a known position on the vehicle and the connection point, determining an initial heading of the agricultural implement based on a predetermined initialization procedure, and calculating a position and orientation of the agricultural implement by computationally combining the projected position data at the connection point and the inertial measurement data from the inertial measurement unit.

According to another aspect, a method provides for generating high-precision agricultural operation maps by receiving position data from a GNSS receiver mounted on a towing vehicle and inertial measurement data from an inertial measurement unit mounted on a towed agricultural implement, projecting the towing vehicle's position data to the connection point between the vehicles through vector generation, rotation, and addition, calculating the towed implement's position and orientation using an extended Kalman filter by computationally combining the projected position data with inertial measurement data, identifying multiple application points on the towed implement that are fixed relative to the connection point, calculating positions of these application points based on the implement's calculated position and orientation, and generating a digital field map comprising precise locations of agricultural operations performed by each application point during field operations.

According to another aspect, a system provides for precision agricultural row following operations by including a GNSS receiver mounted on a first agricultural vehicle, an inertial measurement unit mounted on a first agricultural implement pulled by the first vehicle, and a processing device configured to project GNSS position data to the connection point, determine the implement's initial heading through calibration, calculate the implement's position and orientation by integrating projected position data with inertial measurement data, identify positions of individual application tools on the implement, track and store location data of agricultural operations performed by these tools, and generate a path plan for subsequent field operations based on the stored data, along with a steering control system on a second agricultural vehicle configured to access the stored location data and guide a second agricultural implement during subsequent field operations to align its application points with the stored locations from the first implement's operation.

### BRIEF DESCRIPTION OF THE DRAWINGS

Illustrated embodiments of the disclosure are described in detail below with reference to the attached drawing figures, which are incorporated by reference herein.

FIG. 1 is a flowchart illustrating one example of a methodology.

FIG. 2 illustrates translating from known vehicle position to shared connection point.

FIG. 3 illustrates a projected GNSS position.

FIG. 4 illustrates a tongue length measurement necessary for calibration.

FIG. 5 illustrates a projected GNSS position imagined as self-propelled vehicle.

FIG. 6 is a diagram of one example of a system.

### DETAILED DESCRIPTION

Generally, the present disclosure will discuss an accurate and cost-effective solution for tracking pulled agricultural implements without requiring expensive high-precision GNSS systems mounted directly on the implement. In order to do so, methods and systems are provided for combining existing known vehicle positions along with inertial sensor(s) (sometimes referred to as an inertial measurement unit or IMU) on a non-fixed pulled implement to accurately estimate the exact position of the pulled implement.

These methods generally assume the pulling vehicle shares at least one rigid body point in space with the pulled implement. For example, a ball hitch on a tractor connecting to the tongue of a planter is one example of a hitch point where the pulling vehicle shares at least one rigid body point in space with the pulled implement. The known vehicle position is projected along its rigid body to the shared point with the implement. Thus, location of this shared point may be determined. From there, the inertial sensor(s) on the planter may be used to resolve the heading of the pulled implement relative to the pulling vehicle by reusing the GNSS on the pulling vehicle.

The method and system may first project the vehicle's known GPS position to the connection point (such as hitch pint) between the vehicle (such a tractor) and implement. Then calculations such as those described below may be used to combine this projected position with motion data from the implement's inertial sensor(s). This combination provides accurate tracking of the implement's position and orientation, even when the implement does not follow exactly behind the vehicle such as when turning or on slopes.

Before using the system, the farmer may perform a simple calibration process such as driving in a specific pattern (such as a straight line) or by moving the implement while stationary. Once calibrated, the system may track not just the implement as a whole but also specific points on it such as individual planter row units or sprayer nozzles. This precise tracking enables accurate mapping of field operations, improved steering control, and better planning for future field work, all without the cost and complexity of mounting high-precision GPS systems on every implement.

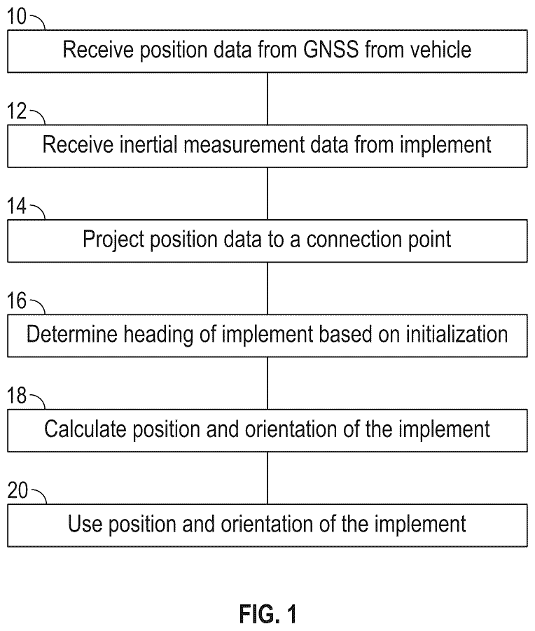

FIG. 1 is a flowchart of a method for tracking a position of an agricultural implement pulled by a vehicle according to one embodiment of the present disclosure. The method begins at step 10 with receiving position data of the vehicle from a global navigation satellite system (GNSS) receiver mounted on the vehicle. The GNSS receiver may be any commercially available GNSS system capable of providing position, velocity, and time information, such as GPS. In preferred embodiments, the GNSS system is a high- accuracy roll-corrected system already installed on the agricultural vehicle, such as a tractor.

At step 12, the method continues with receiving inertial measurement data from an inertial measurement unit mounted on the agricultural implement. The inertial measurement unit includes one or more sensors for detecting motion, orientation, and position changes of the agricultural implement. These sensors may include accelerometers for measuring linear acceleration, gyroscopes for measuring angular velocity, and magnetometers for determining heading relative to magnetic north. The inertial measurement unit may be installed in any orientation and at any position on the implement, as its orientation relative to the implement will be determined through a calibration process discussed later.

At step 14, the method involves projecting the position data of the vehicle to a connection point between the vehicle and the agricultural implement. This projection is based on predefined measurements between a known position on the vehicle (such as the location of the GNSS antenna) and the connection point (such as a hitch ball or drawbar pin). The projection involves generating a vector that shifts the known vehicle location to the connection point, rotating this vector based on the current roll, pitch, and heading of the vehicle, and then adding this rotated vector to the current vehicle location. This projection results in a determination of the GNSS position of the connection point.

At step 16, the method includes determining an initial heading of the agricultural implement based on a predetermined initialization procedure. This initialization procedure may involve several options. One option includes driving the vehicle in a substantially straight line for a predetermined distance, such as three times the tongue length of the implement, to ensure the implement is aligned behind the vehicle. Although the straight line pattern provides a simple approach, it is contemplated that other patterns may be used alone or in addition to a straight line or other approaches may be used to perform initialization. The specific initialization procedure used may depend on the type of implement, field conditions, and operator preference.

At step 18, the method provides for calculating a position and orientation of the agricultural implement by computationally combining the projected position data at the connection point and the inertial measurement data from the inertial measurement unit. This computational combination may be performed using an extended Kalman filter or similar algorithm that treats the projected position data as a virtual GNSS position input located at the connection point. The algorithm effectively models the implement as if it were a self-propelled vehicle with its own GNSS receiver at the connection point, using the inertial data to track changes in orientation and position relative to this virtual GNSS position.

After completing step 18, the system has established an accurate position and orientation tracking capability for the agricultural implement. This tracking information can then be used in step 20 for various agricultural applications as described elsewhere in this specification, including precise mapping of agricultural operations, implement position control, and path planning for subsequent field operations.

Thus, a method is shown and described where a vehicle with a highly accurate position estimate is pulling a non-fixed implement and shares a rigid body point that connects the vehicle and implement and uses only inertial sensor(s) on the implement to calculate a highly accurate position estimate of the implement. The re-use of the GNSS signal already present on the tractor is a significant cost savings and simplification of the mechanical installation compared to existing methods.

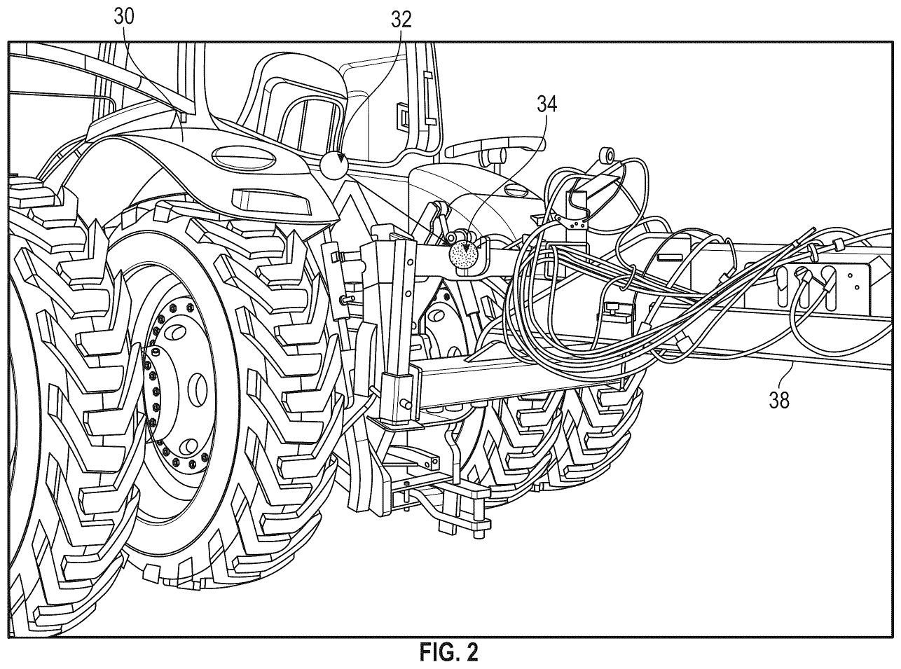

FIG. 2 illustrates an agricultural vehicle 30 such as a tractor and further illustrates a point which is a known vehicle position 32 as well as a shared rigid body connection 34 between the vehicle 30 and the implement 38 which may be a hitch point.

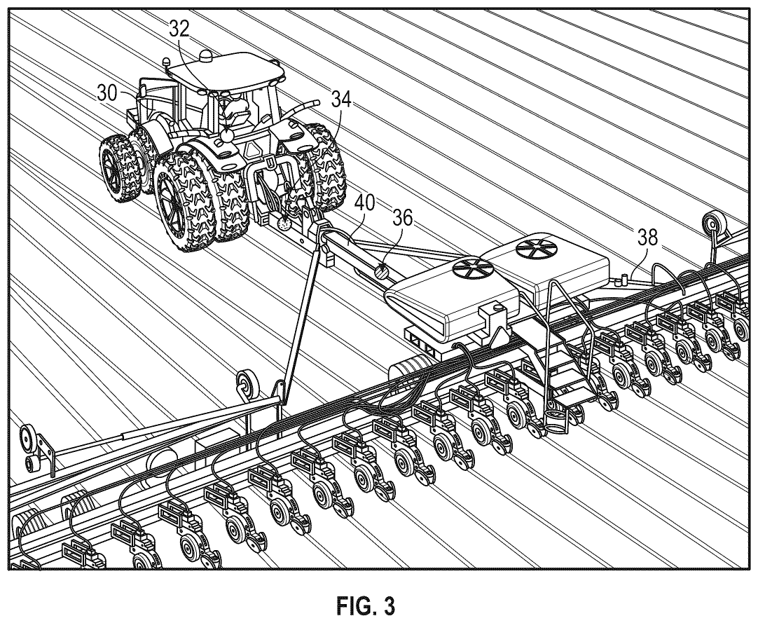

FIG. 3 further illustrates the agricultural vehicle 30 in the form of a tractor and implement 38 in the form of a planter within a field. The known vehicle position 32 is shown as well as the shared rigid body connection 34. Also shown is an inertial measurement unit (IMU) or inertial sensor location 36 which is a point on the implement where the inertial sensor is mounted or secured.

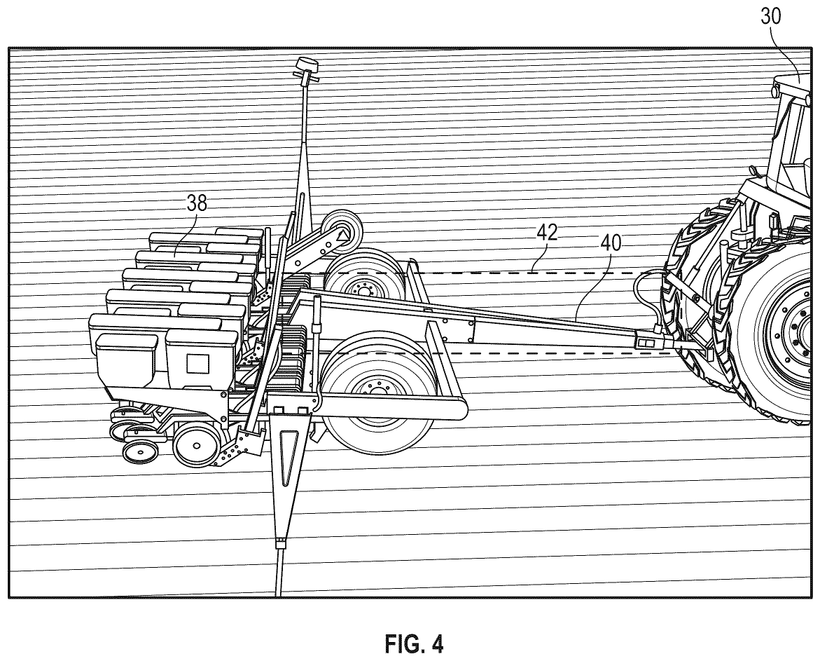

FIG. 4 further illustrates the agricultural vehicle 30 towing the implement 38 with a tongue 40 of the implement shown with a box 42 around the tongue 40, the box 42 showing the length of the tongue 40.

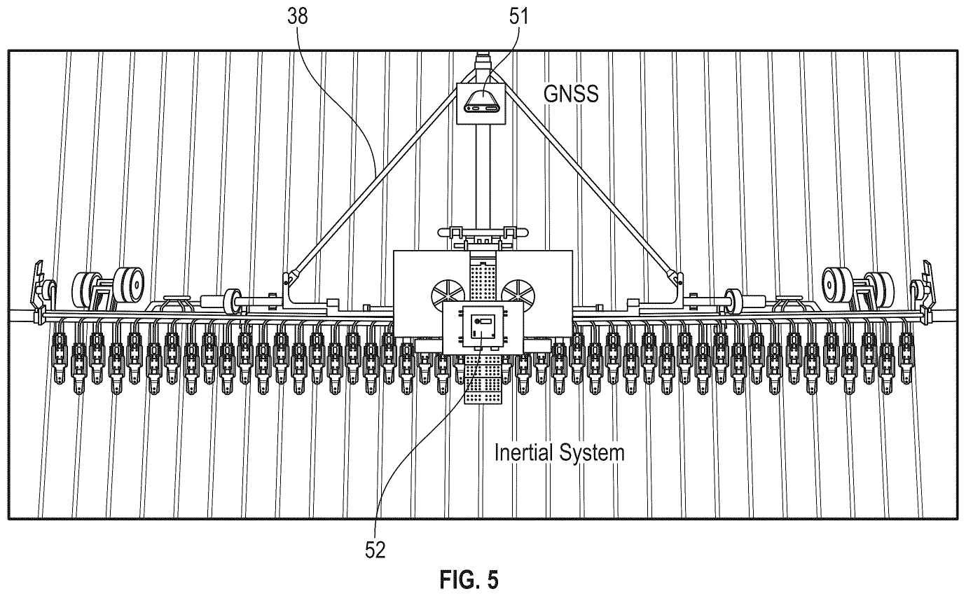

FIG. 5 further illustrates the implement 38 with a projected GNSS point 51 as well as an inertial sensor 52 present. Although the GNSS receiver or antenna is not on the implement, the method allows for a virtual representation of a GNSS receiver as a GNSS location is projected onto the implement as described herein.

### Installation

As previously explained the vehicle may have roll corrected GNSS system which has been installed and calibrated. Or, if not, such a system may be installed and calibrated in the convention manner.

Assuming such a GNSS system is installed on the vehicle, then the inertial sensor may be installed on the implement. The inertial sensor may be installed in any orientation and at any position on the implement. Power must be provided to the inertial sensor which may be performed in any number of ways such as with cables, batteries, or generators present on the implement. Communication to the inertial sensor may be performed through any number of communication channels and protocols. The communications may be performed through any wired or wireless communication protocol, such as CAN or TCP/IP over WiFi.

### Calibration

The user, typically a farmer or someone acting on their behalf obtains measurements from the connection point of the implement to the inertial sensor and the tongue length of the implement. After this, the inertial sensor orientation relative to the implement is also obtained. This calibration may be obtained in various ways. For example, through by-hand or other measurement or a bracket may be placed in a known location to ensure the orientation is a fixed known value, or calculated by performing maneuvers with the vehicle. For example, logging the position of the gravity vector in two opposing directions may be used to calibrate the roll and pitch orientation of the inertial sensor. Finally, the heading may be chosen by the farmer in increments, such as in 90 degree increments showing general direction.

The farmer may also measure or otherwise obtain the distance between the roll corrected GNSS known position of the vehicle to the shared connection point. For example, the GNSS system may report the location in the center of the rear axle and the connection point may be the ball of the hitch. There should be a rigid body between the GNSS reported position and the connection point so the position may be projected.

### Projecting Vehicle Position to Connection Point

The known position on the vehicle may be projected to the shared rigid body connection point between the vehicle and the implement. The previous vehicle measurements are used to generate a vector that shifts the known vehicle location to the connection point, if we assume the vehicle is at (0, 0), is oriented such that its heading is 0 degrees and has no roll or pitch. If the vehicle is not at (0, 0) and/or not facing 0 degrees, the vector needs to first be rotated by the roll, pitch, and heading of the vehicle and then added to the location of the vehicle. The resulting vector now transforms the vehicle position to the connection position in global coordinates and regardless of position and orientation of the vehicle. Adding this vector to the vehicle's current location results in the implement's location at the connection point.

$$ψ = Yaw of the vehicle \\ ϕ = Pitch of the vehicle \\ θ = Roll of the vehicle \\ R = Vector from known vehicle position to connection point$$

$$[ \begin{matrix}{X}_{connection} \\ {Y}_{connection} \\ {Z}_{connection}\end{matrix} ] = {[ \begin{matrix}c ( ψ ) c ( ϕ ) & - s ( ψ ) c ( θ ) & c ( ψ ) s ( ϕ ) + s ( ψ ) s ( θ ) c ( ϕ ) \\ s ( ψ ) c ( ϕ ) & c ( ψ ) c ( θ ) & s ( ψ ) s ( ϕ ) - c ( ψ ) s ( θ ) c ( ϕ ) \\ - s ( ϕ ) & s ( θ ) c ( ϕ ) & c ( θ ) c ( ϕ )\end{matrix} ]}_{\underbrace{Enter Rotation Matrix}} \cdot [ \begin{matrix}{R}_{X} \\ {R}_{Y} \\ {R}_{Z}\end{matrix} ] + [ \begin{matrix}{X}_{known} \\ {Y}_{known} \\ {Z}_{known}\end{matrix} ]$$

### Estimating Implement Heading and Implement Position

Presuming a good initial heading is provided, well-known sensor fusion methods combine a GNSS location and inertial sensor to output a highly accurate, roll corrected position with a stable heading estimation. The vehicle GNSS location projected onto the connection point may be treated as if it were a GNSS position on the implement itself, at the connection point. One example method for converting the projected GNSS location and inertial sensor into high accuracy implement orientation position is the extended Kalman filter (EKF). For purposes here, consider the implement as a self propelled vehicle and use the regular bicycle model along with the standard kinematics equations as the base model for the EKF. The projected GNSS position and inertial sensor serve as the sensor inputs to the EKF.

While the extended Kalman filter (EKF) approach described above represents one effective implementation, it should be understood that the present invention is not limited to any particular computational method. Various other sensor fusion algorithms may be employed to achieve similar results including various filters or fusion algorithms. The bicycle model is similarly provided as one exemplary kinematic model, and other kinematic or dynamic models may be used based on the specific implement characteristics, desired accuracy, or computational resources available.

Further, any application point which is rigid to the implement connection point may be located. This includes but is not limited to, each row of a planter, sprayer nozzles on a pulled sprayer or a planter with a built in sprayer, individual tillage shanks, rollers and disks, and/or other application points.

### Initialization

It is not guaranteed the vehicle begins with the implement perfectly behind in tow and thus the implement may not start with the same heading as the vehicle. One method to address the issue of initial conditions for the Kalman filter is to have the vehicle travel straight long enough to ensure the implement is behind the vehicle prior to initialization. One possible criteria is requiring the vehicle to drive three times the length of the implement's tongue length. For most implements this is enough distance to align the implement with the vehicle. With the vehicle's position well known, the vehicle's curvature can be calculated, such as using the well-known hyper circle fitter technique, and a threshold of curvature chosen to be considered as driving straight. Combining the two criteria, we can wait to initialize the system until the vehicle has driven continuously straight for three tongue lengths. Once the criteria for initialization is met, the implement's Kalman filter may be initialized to have the same heading as the vehicle. After this point, sensor fusion will estimate deviations in the vehicle's and implement's heading.

While the straight-line initialization approach described above provides one effective method, the present invention contemplates numerous alternative initialization techniques. For example, rather than traveling in a straight line, the vehicle could travel in other patterns, or execute a series of predetermined maneuvers that provide sufficient data to establish the implement's initial heading and position relative to the vehicle.

The specific distance requirement of three tongue lengths is likewise presented as an example rather than a limitation. Depending on the implement type, field conditions, coupling mechanism, and desired accuracy, shorter or longer distances may be appropriate. Some implementations may determine readiness for initialization based on time rather than distance, or based on the statistical stability of sensor readings rather than geometric considerations.

Similarly, while the hyper circle fitter technique allows for curvature calculation, other mathematical approaches for determining vehicle path straightness may be employed. Furthermore, alternative initialization procedures may be employed which eliminate the need for straight-line travel entirely.

It should be understood that a number of different applications or uses are enabled by the methods and systems described herein. These include, for example, accurate mapping, controlling implement location, and path planning.

### Accurate Mapping

Knowing the precise location of the implement during an agricultural operation allows accurate visualizations of the field, plants and other elements. Some examples include an augmented reality view of individual seed locations, and over spray visualizations and calculations during end row turns.

### Controlling Implement Location

An accurate position estimation for the implement allows for both passive and active implement steering may be performed. Passive implement steering adjusts the tractor's position to put the implement in the desired location. Active implement steer places an actuator on the implement to force it to follow the desired position.

### Path Planning

Knowing where the implement has and has not been allows for dynamic path planning both in the current operation and in future operations. If a sudden terrain deviation forces the implement out of position faster than the system can adjust this method allows a system to path plan to cover the missed portion of the field. In future operations, such as post planting application, the follow on vehicle can be precisely controlled using the historical position data of the first implement.

For example, the individual rows of a planter can be tracked throughout the planting operation and follow on machines, such as self-propelled sprayers, can use the planted row locations for auto steering or other forms of path planning.

Another example is strip till farming. In this operation, a fertilizing operation injects fertilizer in furrows into the ground using knives or shanks prior to planting. This creates a local space of well fertilized soil while reducing the environmental impact of fertilizer use. This method allows tracking the location of each shank or knife with high accuracy.

The follow on operation, planting, can accurately locate the planter rows and purposefully drive the rows to plant within the fertilized furrows that were previously accurately located. The end result is more fertilizer availability for the seed, less total fertilizer applied to the field and less environmental impact from fertilizer application.

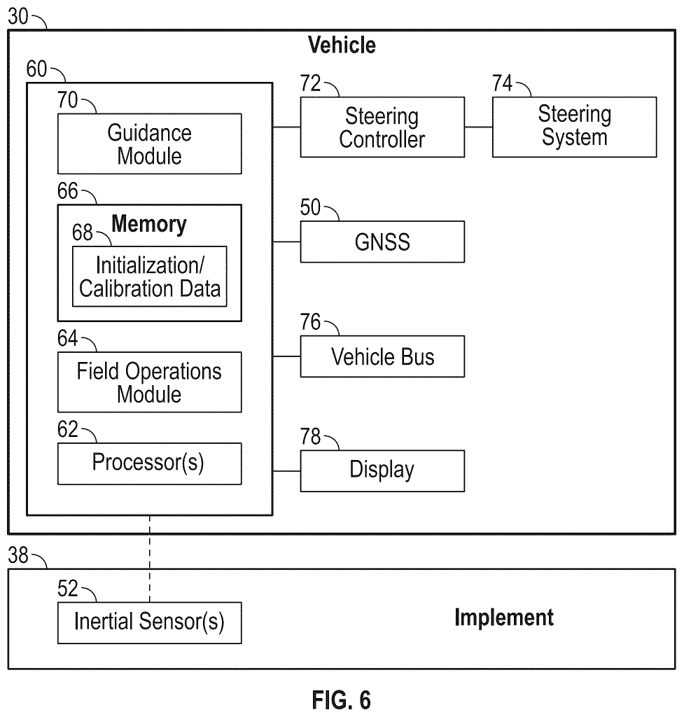

Referring now to FIG. 6, a block diagram of a system is shown for using the pulled implement tracking method. The system illustrates the relationship between various hardware and software components that enable accurate position tracking of an agricultural implement 38 such as a planter or sprayer when pulled by a vehicle 30 such a tractor.

The vehicle 30 may include components mounted on or integrated with the vehicle, and the agricultural implement may include components mounted on the agricultural implement 38.

A GNSS receiver 50 is mounted on the vehicle 30 and provides high-precision position data. This GNSS receiver 50 may include RTK (Real-Time Kinematic) capabilities for centimeter-level accuracy and is typically mounted in a location with clear sky visibility. The GNSS receiver 50 provides position data that serves as the primary reference for the entire system.

The control system 60 includes one or more processors 62 that execute the instructions associated with algorithms for implement position tracking. The processor(s) 62 receive inputs from various sensors or subsystems, process the data, and generate outputs for any number of different functions. The processor(s) 62 may include one or more microprocessors, FPGAs, ASICs, or other computational hardware suitable for real-time processing of position and motion data.

Memory 66 is communicatively coupled to the processor(s) 62 and stores various data used by the system. This includes initialization/calibration data 68 such as the measurements between the GNSS antenna position and the connection point, implement dimensions, and calibration parameters for the inertial sensor(s). The memory 66 may include volatile RAM for real-time operations and non-volatile storage for persistent data.

A guidance module 70 receives the calculated implement position and orientation from the processor(s) 62 and generates guidance information for maintaining the implement on a desired path. The guidance module 70 may implement various path-following algorithms and may accommodate both straight-line and curved-path operations.

A steering controller 72 receives commands from the guidance module 70 and translates them into control signals for the steering system 74. The steering controller 72 may implement either passive implement steering (by controlling the vehicle's position) or active implement steering (by controlling actuators on the implement directly).

A vehicle bus 76 provides communication between the various vehicle subsystems. This may be implemented using standard agricultural protocols such as ISOBUS, CAN bus, or proprietary communication protocols. The vehicle bus 76 enables integration with other vehicle systems and facilitates data exchange between components.

A display 78 provides visual feedback to the operator, showing implement position, coverage maps, and guidance information, and/or other information.

One or more inertial sensor(s) 52 are mounted on the agricultural implement 38. These sensors include accelerometers, gyroscopes, and/or potentially magnetometers that measure the motion and orientation changes of the implement. The inertial sensor(s) 52 are communicatively coupled to the processor(s) 62, either through wired connections or wireless communication protocols. The inertial sensor(s) 52 may also be referred to herein as an inertial measurement unit (IMU) or inertial sensor system.

The field operations module 64 is one example of a module which may use implement position information such as to control actuation of actuators or other electronic controls for controlling application rates associated with spraying operations. The field operations module 64 may provide for controlling other types of field operations as well depending upon the type of implement and/or its use. This module may interface with implement-specific functions such as planter control, sprayer control, or tillage depth management based on the calculated position and orientation of the implement.

The components of the system work together to project the vehicle's GNSS position to the connection point, combine this with inertial data from the implement, and calculate an accurate position and orientation of the implement. This information is then used for guidance, control, and mapping applications that enhance the precision and efficiency of agricultural operations.

The invention is not to be limited to the particular embodiments described herein. In particular, the invention contemplates numerous variations in implementation methods, sensor types, computational algorithms, calibration procedures, initialization techniques, and agricultural applications while remaining within the scope of the core invention of using a vehicle GNSS position projected to a connection point combined with implement-mounted inertial sensor(s) to track implement position. The foregoing description has been presented for purposes of illustration and description. It is not intended to be an exhaustive list or limit any of the invention to the precise forms disclosed. It is contemplated that other alternatives or exemplary aspects are considered included in the invention. The description is merely examples of embodiments, processes or methods of the invention. It is understood that any other modifications, substitutions, and/or additions can be made, which are within the intended spirit and scope of the invention.

What is claimed is:

1. A method for tracking a position of an agricultural implement pulled by a vehicle, the method comprising:
receiving, by a processing device, position data of the vehicle from a global navigation satellite system (GNSS) receiver mounted on the vehicle;
receiving, by the processing device, inertial measurement data from an inertial measurement unit mounted on the agricultural implement;
projecting, by the processing device, the position data of the vehicle to a connection point between the vehicle and the agricultural implement based on predefined measurements between a known position on the vehicle and the connection point;
determining, by the processing device, an initial heading of the agricultural implement based on a predetermined initialization procedure; and
calculating, by the processing device, a position and orientation of the agricultural implement by computationally combining the projected position data at the connection point and the inertial measurement data from the inertial measurement unit.

2. The method of claim 1, wherein calculating the position and orientation of the agricultural implement comprises using an extended Kalman filter that processes the projected position data as a position input at the connection point of the agricultural implement.

3. The method of claim 2, wherein projecting the position data of the vehicle to the connection point comprises: generating a vector that shifts the known position on the vehicle to the connection point; rotating the vector based on roll, pitch, and heading of the vehicle; and adding the rotated vector to the position data of the vehicle.

4. The method of claim 1, wherein the predetermined initialization procedure comprises at least one of: driving the vehicle in a substantially straight line for a predetermined distance; driving the vehicle in a predefined pattern including at least one of a circle, figure eight, or series of turns; and maintaining the vehicle in a stationary position while performing a series of implement movements.

5. The method of claim 4, wherein when the predetermined initialization procedure includes driving the vehicle in a substantially straight line, the method further comprises:
verifying that the vehicle is traveling in the substantially straight line by calculating a curvature of the vehicle's path and comparing the calculated curvature to a threshold value; and
initializing the agricultural implement to have the same heading as the vehicle after confirming the vehicle has traveled the predetermined distance in the substantially straight line.

6. The method of claim 1, further comprising:
calibrating an orientation of the inertial measurement unit relative to the agricultural implement prior to calculating the position and orientation of the agricultural implement, wherein the inertial measurement unit is installed in any orientation and at any position on the agricultural implement.

7. The method of claim 6, wherein calibrating the orientation of the inertial measurement unit comprises at least one of: measuring a gravity vector in at least two opposing directions to determine roll and pitch orientation; performing a series of implement movements at varying speeds to determine orientation based on detected acceleration patterns; or aligning the implement with the vehicle in a known orientation and recording relative orientation offsets.

8. The method of claim 1, further comprising: calculating positions of multiple application points on the agricultural implement based on the calculated position and orientation of the agricultural implement, wherein the multiple application points are fixed relative to the connection point.

9. The method of claim 8, wherein the multiple application points include at least one of:
planter rows, sprayer nozzles, tillage shanks, rollers, and disks.

10. The method of claim 1, further comprising: generating a map of field operations based on the calculated position and orientation of the agricultural implement, the map including precise locations of agricultural operations performed by the agricultural implement.

11. The method of claim 1, further comprising: controlling a position of the agricultural implement using the calculated position and orientation to maintain the agricultural implement on a predetermined path.

12. The method of claim 11, wherein controlling the position of the agricultural implement comprises at least one of: passive implement steering by adjusting the vehicle's position to indirectly position the agricultural implement; and active implement steering by actuating a steering mechanism directly on the agricultural implement.

13. The method of claim 1, further comprising: generating a path plan for a subsequent field operation based on the calculated position and orientation of the agricultural implement during a current field operation.

14. The method of claim 13, further comprising performing strip till farming by: tracking positions of fertilizer application tools during a fertilizing operation; storing location data of fertilized furrows created by the fertilizer application tools; and guiding a planter during a subsequent planting operation based on the stored location data to align planter rows with the fertilized furrows.

15. A system for tracking a position of an agricultural implement pulled by a vehicle, the system comprising:
a global navigation satellite system (GNSS) receiver mounted on the vehicle for providing position data of the vehicle;
an inertial measurement unit mounted on the agricultural implement for providing inertial measurement data; and
a processing device communicatively coupled to the GNSS receiver and the inertial measurement unit, the processing device configured to:
project the position data of the vehicle to a connection point between the vehicle and the agricultural implement based on predefined measurements between a known position on the vehicle and the connection point;
determine an initial heading of the agricultural implement based on a predetermined initialization procedure; and
calculate a position and orientation of the agricultural implement by computationally combining the projected position data at the connection point and the inertial measurement data from the inertial measurement unit.

16. The system of claim 15, wherein the processing device is configured to calculate the position and orientation of the agricultural implement using an extended Kalman filter that processes the projected position data as a position input at the connection point of the agricultural implement.

17. The system of claim 15, wherein the processing device is further configured to:
calculate positions of multiple application points on the agricultural implement based on the calculated position and orientation of the agricultural implement; and
generate a map of field operations including precise locations of agricultural operations performed at the multiple application points.

18. The system of claim 15, wherein the processing device is further configured to:
control a position of the agricultural implement using the calculated position and orientation to maintain the agricultural implement on a predetermined path; and
generate a path plan for a subsequent field operation based on the calculated position and orientation of the agricultural implement during a current field operation.

19. The system of claim 15, wherein the inertial measurement unit is installed in any orientation and at any position on the agricultural implement, and wherein an orientation of the inertial measurement unit relative to the agricultural implement is determined through calibration prior to calculating the position and orientation of the agricultural implement.

20. A non-transitory computer-readable medium storing instructions that, when executed by a processor, cause the processor to perform operations comprising: receiving position data of a vehicle from a global navigation satellite system (GNSS) receiver mounted on the vehicle;
receiving inertial measurement data from an inertial measurement unit mounted on an agricultural implement pulled by the vehicle; projecting the position data of the vehicle to a connection point between the vehicle and the agricultural implement based on predefined measurements between a known position on the vehicle and the connection point; determining an initial heading of the agricultural implement based on a predetermined initialization procedure; and calculating a position and orientation of the agricultural implement by computationally combining the projected position data at the connection point and the inertial measurement data from the inertial measurement unit.
